(19) United States
(12) Patent Application Publication
(10) Pub. No.: US 2022/0297489 A1
(43) Pub. Date: Sep. 22, 2022

(54) TRAILING ARM FOR OFF-ROAD VEHICLE REAR SUSPENSIONS

(71) Applicant: Robby Gordon, Charlotte, NC (US)

(72) Inventor: Robby Gordon, Charlotte, NC (US)

(21) Appl. No.: 17/696,627

(22) Filed: Mar. 16, 2022

Related U.S. Application Data
(60) Provisional application No. 63/162,466, filed on Mar. 17, 2021.

(51) Int. Cl. B60G 7/00; B60G 9/02

(52) U.S. Cl. CPC B60G 7/001; B60G 9/02; B60G 2200/20; B60G 2206/124

(57) ABSTRACT

An apparatus and methods are provided for a trailing arm for a rear suspension of an off-road vehicle. The trailing arm comprises an axle support that has a cylindrical shape for supporting roller bearings whereby a wheel hub is rotatable relative to the trailing arm. A joined control arm extends forward of the axle support to an outboard control arm and an inboard control arm. The outboard and inboard control arms are configured to hingedly couple to a chassis of the vehicle. An outboard chassis mount and an inboard chassis mount operate as pivots that place the trailing arm into a hinged relationship with the chassis. The tailing arm is configured to be interchangeable between a driver side and a passenger side of the off-road vehicle. Bulkheads are arranged within an interior chamber of the tailing arm and configured to impart structural integrity to the tailing arm.

This application claims the benefit of and priority to U.S. Provisional Application, entitled “Trailing Arm For Off-Road Vehicle Rear Suspensions,” filed on Mar. 17, 2021, and having application Ser. No. 63/162,466, the entirety of said application being incorporated herein by reference.

### FIELD

Embodiments of the present disclosure generally relate to vehicle suspension systems. More specifically, embodiments of the disclosure relate to an apparatus and methods for a universal trailing arm for rear suspensions of off-road vehicles.

### BACKGROUND

Off-road vehicles enjoy an enthusiastic following because of their many uses and versatility. As a result, several types of motorsports involve racing of various types of off-road vehicles. For example, competitions exist that are dedicated to various types of terrain, such as rally, desert racing, and rock-crawling. Besides their use in various motorsports, off-road vehicles commonly are used for sight-seeing and traveling to areas that may not be accessed by way of standard, paved roads.

The use of higher clearance, higher traction vehicles enables off-road vehicles to access trails and roads having rough, low traction surfaces that may not be traversed using a standard, on-road vehicle. As such, off-road vehicles typically comprise larger wheels, wider tires, and suspension configurations that are specifically engineered for use in off-road applications. As a consequence of such suspension configurations, as well as the rough terrain typically traversed, driver and passenger safety is a crucial concern. For example, drivers and passengers typically must be wear safety restraints during off-road travel. A wide variety of different types of safety harnesses are available for use with off-road vehicles.

Unlike on-road vehicles, such as passenger cars, off-road vehicles typically are open, often lacking windows, doors, and body panels common to passenger cars. A chassis comprising a structural arrangement of welded tubes typically is configured to support components of the off-road vehicle. For example, a front portion of the chassis is configured to support a front suspension of the off-road vehicle and various components of the off-road vehicle, such as a steering gear, a front differential, and the like. A rear portion of the chassis is configured to support a rear suspension of the off-road vehicle, such as rear trailing arms, as well as support various drivetrain components, such as a transaxle, a rear differential, an engine, and the like. Further, a roll cage or canopy comprising a welded tube structure coupled to the chassis is configured to protect the driver and passengers in the event of a rollover situation.

Trailing arm suspensions are well known and commonly used in off-road vehicles such as four-wheeled buggies. A typical trailing arm suspension comprises a trailing arm having one end pivotally connected to a vehicle frame or chassis through a frame bracket and another end connected to the vehicle frame by a spring or strut. The trailing arm supports an axle to which the vehicle wheels are mounted. Road-induced reaction forces acting on the wheels are controlled by the pivoting of the trailing arm in response to these forces, with the forces being resisted by the spring.

Given that off-road vehicles routinely travel over very rough terrain, such as mountainous regions, and are prone to tipping over, there is a desire to improve the mechanical strength, safety, convenience, and comfort of off-road vehicles, while at the same improving the performance of such vehicles.

### SUMMARY

An apparatus and methods are provided for a trailing arm for a rear suspension of an off-road vehicle. The trailing arm comprises an axle support that has a cylindrical shape for supporting roller bearings whereby a wheel hub is rotatable relative to the trailing arm. A joined control arm extends forward of the axle support to an outboard control arm and an inboard control arm. The outboard and inboard control arms are configured to hingedly couple to a chassis of the vehicle. An outboard chassis mount and an inboard chassis mount operate as pivots that place the trailing arm into a hinged relationship with the chassis. The tailing arm is configured to be interchangeable between a driver side and a passenger side of the off-road vehicle. Bulkheads are arranged within an interior chamber of the tailing arm and configured to impart structural integrity to the tailing arm.

In an exemplary embodiment, a trailing arm for a rear suspension of an off-road vehicle comprises: an axle support for coupling a wheel hub; a joined control arm extending forward of the axle support; an outboard control arm extending forward to an outboard chassis mount; and an inboard control arm extending forward to an inboard chassis mount.

In another exemplary embodiment, the joined control arm is disposed at an angle with respect to a centerline of the trailing arm. In another exemplary embodiment, the angle gives rise to a valley between the outboard control arm and the joined control arm. In another exemplary embodiment, the valley provides clearance between the outboard control arm and wheels having a large sidewall width, as often is the case with off-road tires.

In another exemplary embodiment, the axle support has a cylindrical shape that is configured to support roller bearings whereby the wheel hub is rotatable relative the trailing arm. In another exemplary embodiment, the axle support includes an inboard-facing opening that is configured to receive the CV joint. In another exemplary embodiment, the inboard-facing opening enables the CV joint to be fastened to the wheel hub so as to place the wheel hub into rotational communication with the engine. In another exemplary embodiment, the axle support serves as a rigid shield to protect the CV joint from damage due to rocks and road debris, particularly encountered during off-road driving.

In another exemplary embodiment, the outboard chassis mount is configured to couple the outboard control arm to a chassis of the off-road vehicle. In another exemplary embodiment, the outboard chassis mount is configured to operate as a pivot that places the trailing arm into a hinged relationship with the chassis. In another exemplary embodiment, the inboard chassis mount is configured to couple the inboard control arm to a chassis of the off-road vehicle. In another exemplary embodiment, the inboard chassis mount is configured to operate as a pivot that allows the trailing arm to hingedly rotate relative to the vehicle chassis.

In another exemplary embodiment, the outboard chassis mount and the inboard chassis mount allow a wheel of the off-road vehicle to undergo a substantially vertical motion according to the terrain over which the wheel is rolling while diminishing a transfer of the vertical motion to the vehicle. In another exemplary embodiment, the outboard chassis mount comprises a rod-end variety of chassis mount and the inboard chassis mount comprises a bushing variety of mount. In another exemplary embodiment, the outboard chassis mount and the inboard chassis mount are disposed at an offset angle relative to a perpendicular of the centerline of the vehicle chassis. In another exemplary embodiment, the offset angle produces a change in camber angle of the wheel, such that tracking of the wheel remains substantially unchanged throughout a range of vertical motion of the trailing arm during operation of the vehicle.

In another exemplary embodiment, the tailing arm is configured to be substantially symmetric above and below a bisecting plane defined by all of a centerline of the outboard control arm, a centerline of the inboard control arm, and a centerline of the axle support. In another exemplary embodiment, the trailing arm is interchangeable between a driver side and a passenger side of the off-road vehicle. In another exemplary embodiment, a recess is disposed between the outboard control arm and the inboard control arm and configured for mounting a strut to the trailing arm. In another exemplary embodiment, a strut mount is disposed within the recess and centered along the bisecting plane of the trailing arm. In another exemplary embodiment, the strut mount is configured to hingedly receive the strut. In another exemplary embodiment, a sway bar mount is disposed between the outboard control arm and the inboard control arm. In another exemplary embodiment, the sway bar mount is centered along the bisecting plane of the trailing arm.

In another exemplary embodiment, an interior chamber is disposed throughout the outboard control arm and the inboard control arm and the joined control arm. In another exemplary embodiment, bulkheads are arranged into an overlapping angled configuration within the interior chamber. In another exemplary embodiment, the bulkheads are configured to improve the durability of the trailing arm and reduce relative movement between the outboard control arm and the inboard control arm during travel over rough terrain.

In an exemplary embodiment, a method for a trailing arm for a suspension of an off-road vehicle comprises: configuring an axle support for coupling a wheel hub; extending a joined control arm forward of the axle support; extending an outboard control arm forward to an outboard chassis mount; and extending an inboard control arm forward to an inboard chassis mount.

In another exemplary embodiment, extending the outboard control arm includes configuring the outboard chassis mount to operate as a pivot that places the trailing arm into a hinged relationship with a chassis of the off-road vehicle. In another exemplary embodiment, extending the inboard chassis mount includes configuring the inboard chassis mount to operate as a pivot that allows the trailing arm to hingedly rotate relative to the chassis.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an exemplary embodiment of an off-road vehicle that is configured to seat up to four occupants and includes rear suspension trailing arms in accordance with the present disclosure;

FIG. 2 illustrates a bottom view of an exemplary embodiment of an off-road vehicle that includes rear suspension trailing arms according to the present disclosure;

FIG. 3 illustrates an isometric outboard view of an exemplary embodiment of a rear suspension trailing arm that may be implemented in the off-road vehicle of FIG. 2, in accordance with the present disclosure;

FIG. 4 illustrates an isometric inboard view of the embodiment of the rear suspension trailing arm of FIG. 3, in accordance with the present disclosure;

FIG. 5 illustrates an upper and/or bottom plan view of the embodiment of the rear suspension trailing arm of FIGS. 3-4 according to the present disclosure; and

FIG. 6 illustrates a cross-sectional view of the embodiment of the rear suspension trailing arm of FIG. 3, taken along a midline, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the universal rear suspension trailing arms and methods disclosed herein may be practiced without these specific details. In other instances, specific numeric references such as “first hinge,” may be made. However, the specific numeric reference should not be interpreted as a literal sequential order but rather interpreted that the “first hinge” is different than a “second hinge.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Trailing arm suspensions are well known and commonly used in off-road vehicles such as four-wheeled buggies. A typical trailing arm suspension comprises a trailing arm having one end pivotally connected to a vehicle frame or chassis through a frame bracket and another end connected to the vehicle frame by a spring or strut. The trailing arm supports an axle to which the vehicle wheels are mounted. Road-induced reaction forces acting on the wheels are controlled by the pivoting of the trailing arm in response to these forces, with the forces being resisted by the spring. Given that off-road vehicles routinely travel over very rough terrain, such as mountainous regions, and are prone to tipping over, there is a desire to improve the mechanical strength, safety, convenience, and comfort of off-road vehicles, while at the same improving the performance of such vehicles. Embodiments disclosed herein provide an apparatus and methods for a universal trailing arm for rear suspensions of off-road vehicles.

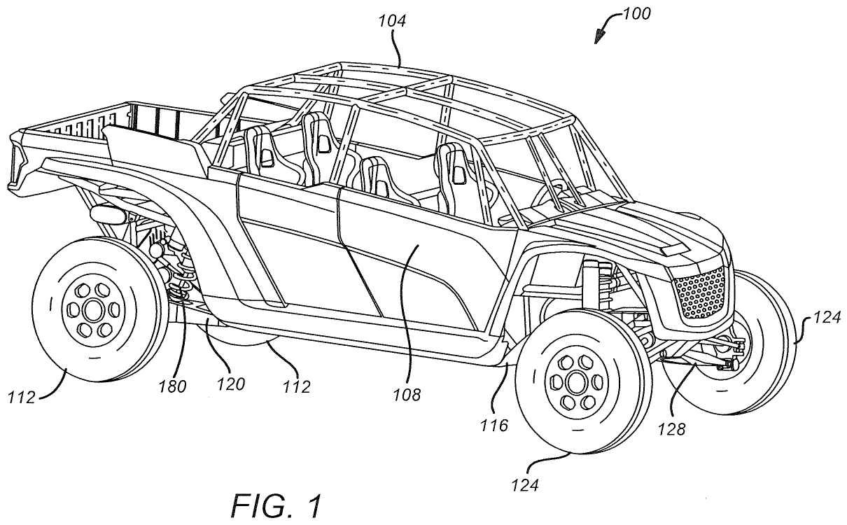

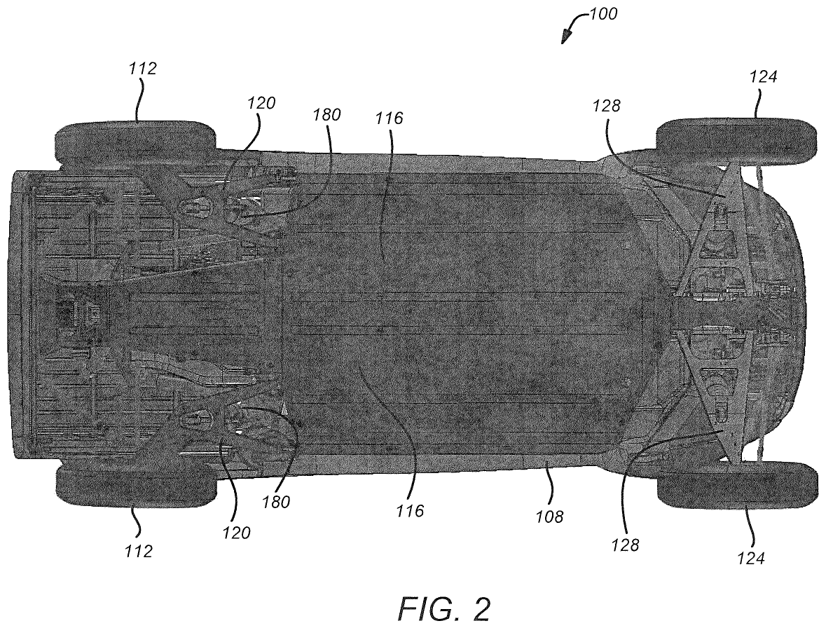

FIGS. 1-2 illustrate an exemplary embodiment of an off-road vehicle 100 that is particularly suitable for implementation of universal rear suspension trailing arms in accordance with the present disclosure. As disclosed hereinabove, the off-road vehicle 100 generally is of a Utility Task Vehicle (UTV) variety that seats up to four occupants, includes a roll-over protection system 104, and may have a cab enclosure 108. As best shown in FIG. 2, rear wheels 112 of the off-road vehicle 100 are operably coupled with a chassis 116 by way of rear suspension trailing arms 120. Front wheels 124 are operably coupled with the chassis 116 by way of a front suspension system 128. It should be understood, however, that the rear suspension trailing arms 120 disclosed herein are not to be limited to the specific off-road vehicle 100 shown in FIG. 1, but rather the rear suspension trailing arms 120 may be incorporated into a wide variety of vehicles, other than the off-road vehicle 100 of FIG. 1, without limitation.

As will be recognized by those skilled in the art, the rear wheel 112 generally is fastened to the rear suspension trailing arm 120 by way of a wheel hub (not shown). Preferably, the wheel hub is rotatably attached to the rear suspension trailing arm 120 by way of one or more suitably sized roller bearings. As will be further recognized, the rear wheel 112 and wheel hub generally are driven by way of a constant velocity (CV) joint configured to convey torque from an engine of the vehicle.

Moreover, although the rear suspension trailing arm 120 illustrated and described herein is best suited for use in a rear suspension of a vehicle, it is contemplated that the trailing arm 120 is not to be limited to rear suspensions, but rather in some embodiments, the trailing arm 120 may be configured for use in a front suspension of a vehicle, without limitation, and without deviating beyond the spirit and scope of the present disclosure. For the sake of brevity, however, the trailing arm 120 is hereinafter discussed in connection with a rear suspension of a vehicle. As such, terms conveying a relative positioning of components or portions comprising the trailing arm 120, such as “forward,” “rearward,” “back,” “front,” “proximal,” and “distal,” should not be construed as limiting in nature, but rather such terms should be understood merely as tools used to convey the details of the invention to those of ordinary skill in the art.

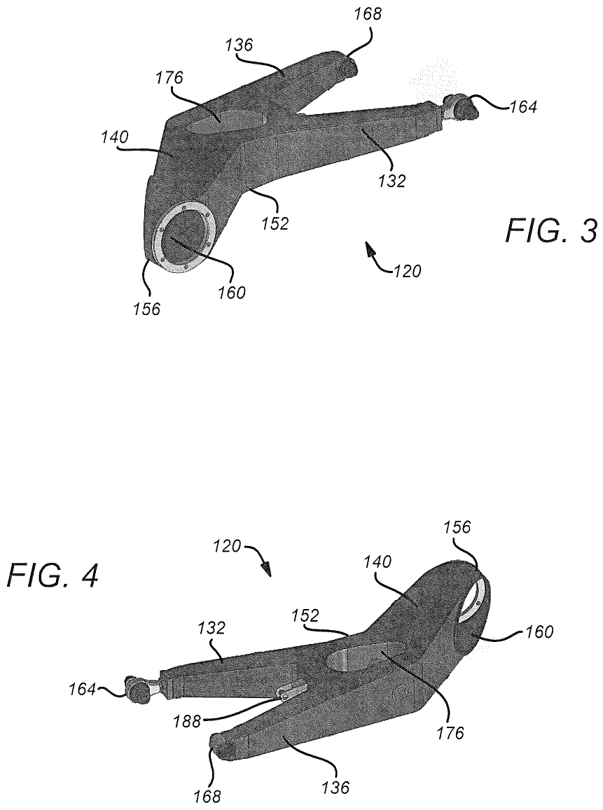

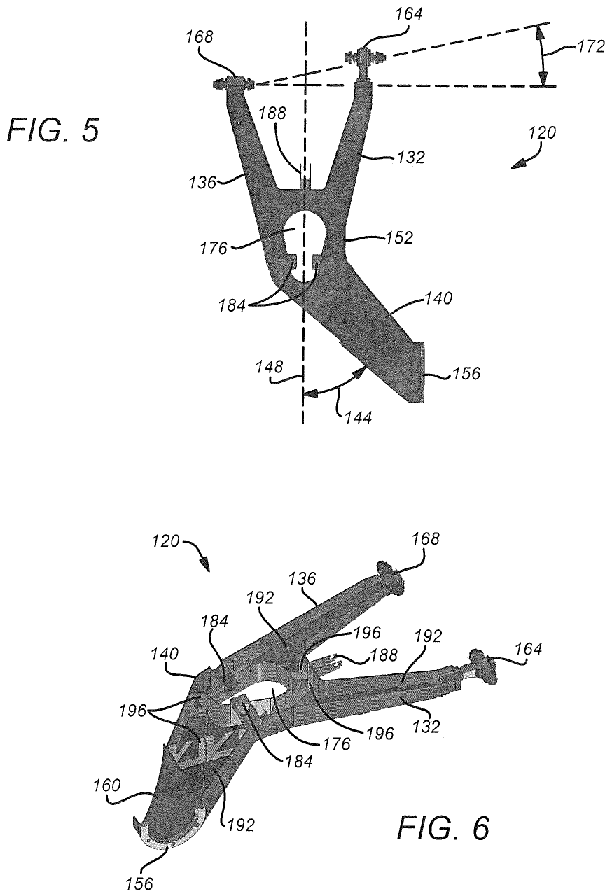

Turning, now, to FIGS. 3-4, a universal rear suspension trailing arm 120 (hereinafter, “trailing arm 120”) is shown comprising an outboard control arm 132 and an inboard control arm 136 that extend forwardly from a joined control arm 140. As best shown in FIG. 5, the joined control arm 140 is disposed at an angle 144 with respect to a centerline 148 of the trailing arm 120. The angle 144 gives rise to a valley 152 between the outboard control arm 132 and the joined control arm 140. The valley 152 provides clearance between the outboard control arm 132 and wheels 112 having a large sidewall width, as often is the case with off-road tires. At a rear-most end of the joined control arm 140 is an axle support 156 that is configured to couple a wheel hub (not shown) to the trailing arm 120. As will be appreciated, the axle support 156 has a cylindrical shape that is configured to support the above-mentioned roller bearings whereby the wheel hub is rotatable relative the trailing arm 120. As best shown in FIG. 4, the axle support 156 includes an inboard-facing opening 160 that is configured to receive the CV joint. Thus, the inboard-facing opening enables the CV joint to be fastened to the wheel hub so as to place the wheel hub into rotational communication with the engine. As will be appreciated, the axle support 156 further serves as a rigid shield to protect the CV joint from damage due to rocks and road debris, particularly encountered during off-road driving.

In general, the trailing arm 120 is configured to be coupled with the vehicle chassis 116 by way of one or more chassis mounts. In the embodiments illustrated and discussed herein, an outboard chassis mount 164 couples the outboard control arm 132 to the vehicle chassis 116. The outboard chassis mount 164 operates as a pivot that places the trailing arm 120 into a hinged relationship with the chassis 116. A second, inboard chassis mount 168 couples the inboard control arm 136 to the chassis 116. Similar to the outboard chassis mount 164, the inboard chassis mount 168 operates as a pivot that allows the trailing arm 120 to hingedly rotate relative to the vehicle chassis 116. Thus, the outboard and inboard chassis mounts 164, 168 allow the wheel 112 to undergo a substantially vertical motion according to the terrain over which the wheel 112 is rolling while diminishing a transfer of the vertical motion to the vehicle 100.

In the embodiment illustrated herein, the outboard chassis mount 164 comprises a rod-end variety of chassis mount and the inboard chassis mount 168 comprises a bushing variety of mount. It should be understood, however, that the outboard and inboard chassis mounts 164, 168 are to be limited to the specific varieties of mounts illustrated and discussed herein. Rather, it should be borne in mind that the outboard and inboard chassis mounts 164, 168 may comprise any of various other types of mounts, such as are found to be beneficial, without limitation.

As best shown in FIG. 5, the outboard and inboard chassis mounts 164, 168 are disposed at an offset angle 172 relative to a perpendicular of the centerline 148 of the vehicle chassis 116. The offset angle 172 may range between 0 and about 20 degrees or more, without limitation. It is contemplated that the offset angle 172 of the outboard and inboard chassis mounts 164, 168 produces a change in camber angle of the wheel 112, such that tracking of the wheel 112 remains substantially unchanged throughout a range of vertical motion of the trailing arm 120 during operation of the vehicle 100.

FIG. 6 illustrates a cross-sectional view of the trailing arm 120, taken along a bisecting plane defined by centerlines of the outboard control arm 132, the inboard control arm 136, and the axle support 144. As shown in FIG. 6, the trailing arm 120 is configured to be substantially symmetric above and below the bisecting plane. The symmetry of the trailing arm 120 facilitates interchangeability of the trailing arm 120 between a driver side and a passenger side of the vehicle 100. As shown in FIG. 2, for example, identical trailing arms 120 may be installed on the driver side and passenger side of the vehicle 100.

Moreover, a recess 176 is disposed between the outboard and inboard control arms 132, 136 and is configured for mounting a strut 180, as best shown in FIG. 2. As shown in FIG. 6, a strut mount 184 is disposed within the recess 176 and centered along the bisecting plane of the trailing arm 120. The strut mount 184 is configured to hingedly receive a suitable strut, such as the strut 180 shown in FIG. 2. As will be appreciated, aligning the strut mount 184 with the bisecting plane of the trailing arm 120 facilitates a substantially identical coupling of struts 180 within the recesses 176 of trailing arms 120 disposed on the driver side and passenger side of the vehicle 100. Further, the trailing arm 120 includes a sway bar mount 188 disposed between the outboard and inboard control arms 132, 136. The sway bar mount 188 is centered along the bisecting plane of the trailing arm 120 so as to facilitating a substantially identical coupling of a sway bar with trailing arms 120 disposed on the driver side and passenger side of the vehicle 100.

With continuing reference to FIG. 6, an interior chamber 192 is disposed throughout the outboard and inboard control arms 132, 136 as well as the joined control arm 140. As further shown in FIG. 6, bulkheads 196 are arranged into an overlapping angled configuration within the interior chamber 192. It is contemplated that the bulkheads 196, as well as the components comprising the control arms 132, 136, 140, preferably are welded, or otherwise attached together so as to impart structural integrity to the trailing arm 120. It is further contemplated that the bulkheads 196 and the welded assembly of the control arms 132, 136, 140 generally improves the durability of the trailing arm 120 and reduces relative movement between the outboard control arm 132 and the inboard control arm 136 during travel over rough terrain.

While the universal rear suspension trailing arms and methods have been described in terms of particular variations and illustrative figures, those of ordinary skill in the art will recognize that the universal rear suspension trailing arms are not limited to the variations or figures described. In addition, where methods and steps described above indicate certain events occurring in certain order, those of ordinary skill in the art will recognize that the ordering of certain steps may be modified and that such modifications are in accordance with the variations of the universal rear suspension trailing arms. Additionally, certain of the steps may be performed concurrently in a parallel process, when possible, as well as performed sequentially as described above. To the extent there are variations of the universal rear suspension trailing arms, which are within the spirit of the disclosure or equivalent to the universal rear suspension trailing arms found in the claims, it is the intent that this patent will cover those variations as well. Therefore, the present disclosure is to be understood as not limited by the specific embodiments described herein, but only by scope of the appended claims.

What is claimed is:

1. A trailing arm for a rear suspension of an off-road vehicle, comprising:
an axle support for coupling a wheel hub;
a joined control arm extending forward of the axle support;
an outboard control arm extending forward to an outboard chassis mount; and
an inboard control arm extending forward to an inboard chassis mount.

2. The trailing arm of claim 1, wherein the joined control arm is disposed at an angle with respect to a centerline of the trailing arm.

3. The trailing arm of claim 2, wherein the angle gives rise to a valley between the outboard control arm and the joined control arm.

4. The trailing arm of claim 3, wherein the valley provides clearance between the outboard control arm and wheels having a large sidewall width, as often is the case with off-road tires.

5. The trailing arm of claim 1, wherein the outboard chassis mount and the inboard chassis mount allow a wheel of the off-road vehicle to undergo a substantially vertical motion according to the terrain over which the wheel is rolling while diminishing a transfer of the vertical motion to the vehicle.

6. The trailing arm of claim 5, wherein the outboard chassis mount comprises a rod-end variety of chassis mount and the inboard chassis mount comprises a bushing variety of mount.

7. The trailing arm of claim 5, wherein the outboard chassis mount and the inboard chassis mount are disposed at an offset angle relative to a perpendicular of the centerline of the vehicle chassis.

8. The trailing arm of claim 7, wherein the offset angle produces a change in camber angle of the wheel, such that tracking of the wheel remains substantially unchanged throughout a range of vertical motion of the trailing arm during operation of the vehicle.

9. The trailing arm of claim 1, wherein the tailing arm is configured to be substantially symmetric above and below a bisecting plane defined by all of a centerline of the outboard control arm, a centerline of the inboard control arm, and a centerline of the axle support.

10. The trailing arm of claim 9, wherein the trailing arm is interchangeable between a driver side and a passenger side of the off-road vehicle.

11. The trailing arm of claim 10, wherein a recess is disposed between the outboard control arm and the inboard control arm and configured for mounting a strut to the trailing arm.

12. The trailing arm of claim 11, wherein a strut mount is disposed within the recess and centered along the bisecting plane of the trailing arm.

13. The trailing arm of claim 10, wherein a sway bar mount is disposed between the outboard control arm and the inboard control arm.

14. The trailing arm of claim 13, wherein the sway bar mount is centered along the bisecting plane of the trailing arm.

15. The trailing arm of claim 1, wherein an interior chamber is disposed throughout the outboard control arm and the inboard control arm and the joined control arm.

16. The trailing arm of claim 15, wherein bulkheads are arranged into an overlapping angled configuration within the interior chamber.

17. The trailing arm of claim 16, wherein the bulkheads are configured to improve the durability of the trailing arm and reduce relative movement between the outboard control arm and the inboard control arm during travel over rough terrain.

18. A method for a trailing arm for a suspension of an off-road vehicle, comprising:
configuring an axle support for coupling a wheel hub;
extending a joined control arm forward of the axle support;
extending an outboard control arm forward to an outboard chassis mount; and
extending an inboard control arm forward to an inboard chassis mount.

19. The method of claim 18, wherein extending the outboard control arm includes configuring the outboard chassis mount to operate as a pivot that places the trailing arm into a hinged relationship with a chassis of the off-road vehicle.

20. The method of claim 19, wherein extending the inboard chassis mount includes configuring the inboard chassis mount to operate as a pivot that allows the trailing arm to hingedly rotate relative to the chassis.
